(19) United States
(12) Patent Application Publication
(10) Pub. No.: US 2004/0228587 A1
(43) Pub. Date: Nov. 18, 2004

(54) Method for manufacturing a light-transmitting module

(76) Inventors: Jiro Shinkai, Yokohama-shi (JP); Hisao Go, Yokohama-shi (JP); Kiyoshi Kato, Yokohama-shi (JP); Toshiaki Kihara, Yokohama-shi (JP)

Correspondence Address: SMITH, GAMBRELL & RUSSELL, LLP, 1850 M STREET, N.W., SUITE 800, WASHINGTON, DC, 20036, US

(21) Appl. No.: 10/800,003

(22) Filed: Mar. 15, 2004

(30) Foreign Application Priority Data
Mar. 17, 2003 (JP) 2003-072041

(51) Int. Cl. G02B 6/36

(52) U.S. Cl. 385/92

(57) ABSTRACT

This invention provides a method of manufacturing a light-transmitting module, in which defective light-transmitting device can be found before the device is to be installed within a housing. According to the invention, the light-transmitting device is mounted on an insulating sub-mount, and the sub-mount is provided on a conductive carrier. A first post, made of insulating material and a metal film provided on an upper surface thereof, is also provided on the carrier. The first electrode of the light-transmitting device is electrically connected the metal film provided on the first post, while the second electrode of the light-transmitting device is electrically connected to the carrier. By probing the metal film and the carrier, the light-transmitting device can be carried out its screening test before the carrier with the light-transmitting device is installed within the housing.

### BACKGROUND OF THE INVENTION

1. Filed of the Invention

This invention relates to a method for manufacturing a light-transmitting module.

2. Related Prior Art

An optical module, especially light-transmitting module, generally includes a sub-mount for mounting the light-transmitting device and a carrier for installing the sub-mount. The sub-mount and the carrier are enclosed within in a housing, and a plurality of lead terminals connected to the light-transmitting device in the housing extrudes from the housing. In such module, since the screening test is performed after the light-transmitting device is installed within the housing, wire-bonded to the lead terminal and practically supplied with the bias current, because the probe for supplying the current to the device can not directly touch thereto.

However, when the defective device has found at the screening test after installing the light-transmitting device into the housing, all components of the module must be dropped. Therefore, one object of the present invention is to provide a method for manufacturing the light-transmitting module, in which the screening test can be performed before installing the light-transmitting device into the housing.

### SUMMARY OF THE INVENTION

One aspect of the present invention, a method for manufacturing a light-transmitting module is provided. The light-transmitting module includes a light-transmitting device, a sub-mount, an electrically conductive carrier, a first post, a lens and a housing for enclosing the light-transmitting device, the sub-mount, the first post and the lens therein. The light-transmitting device has a first electrode and a second electrode, and emits light by supplying a current between the first electrode and the second electrode. The sub-mount mounts the light-transmitting device thereon. The first post is made of insulating material with a metal film on an upper surface thereof. The method comprises the steps of (a) mounting a sub-mount and a first post on the carrier; (b) electrically connecting the first electrode of the light-transmitting device to the metal film on the first post with a bonding-wire; (c) testing the light-transmitting device by supplying the current through a fist probe touching the metal film on the first post.

According to the present method, a screening test for the light-transmitting device can be carried out before the light-transmitting device is installed within the housing. Therefore, when a defective device is found, only the defective device may be replaced but other components may be left with its original specification.

The sub-mount may be made of insulating material or electrically conductive material. When the sub-mount is insulating, the sub-mount provides a metal film thereon and the light-transmitting device is mounted such that the first electrode thereof faces and in contact with the metal film on the sub-mount. On the other hand, the sub-mount is electrically conductive, the light-transmitting device is mounted on the sub-mount such that the second electrode thereof faces and is in contact with the sub-mount.

Moreover in the present invention, the method may further include, subsequently to the testing step of the light-transmitting device, the steps of (d) mounting the lens on the carrier and aligning the lens with the light-transmitting device; and (e) cutting the electrical connection between the first electrode and the metal film on the first post.

The alignment of the lens is done at the condition that the light-transmitting device is supplied with the current through the first probe touching the metal film on the first post and the second probe touching the carrier. Since this condition may escape from heat generated by another active electric components on the carrier, an optical coupling between the light-transmitting device and the lens by the alignment may be reliably preformed.

Moreover, the bonding-wire connecting the first electrode of the light-transmitting device and the metal film on the first post is cut after the steps of testing the light-transmitting device and aligning the lens, the light-transmitting module may be escaped from parasitic capacitance due to the first post, thereby maintaining the high frequency performance of the light-transmitting module.

### BRIEF DESCRIPTION OF DRAWINGS

FIG. 1 is a partially broken perspective view of a light-transmitting module according to the first embodiment of the present invention;

FIG. 2 is a perspective view of the first post;

FIG. 3 is a perspective view of the carrier, on which the sub-mount, the first and second posts are mounted;

FIG. 4 is a perspective view of the carrier, in which the light-transmitting device is wire-bonded to the first and second posts with bonding-wires;

FIG. 5A is a perspective view of the carrier in which the screening test is performed, where the first probe touches the first post and the second probe touches the second post, and FIG. 5B also shows the carrier when the screening test is performed in which the second probe directly touches carrier;

FIG. 6 is a perspective view showing that the carrier is installed within the housing;

FIG. 7 is a perspective view of the housing in which the driver is installed on the carrier;

FIG. 8 is a perspective view showing that the carrier is contained in the housing and the first lens is optically aligned to the light-transmitting device;

FIG. 9 is a partially broken perspective view of the second embodiment according to the present invention;

FIG. 10 is a perspective view of the carrier, in which the light-transmitting device, the first and third posts are wire-bonded with bonding-wires; and

FIG. 11 is a perspective view showing that the screening test for the light-transmitting device is performed.

### DETAILED DESCRIPTION OF PREFERRED EMBODIMENTS

The first embodiment of the present invention will be described as referring to accompanying drawings. In drawings and explanations, same elements will be referred by same symbols and numerals without overlapping explanation.

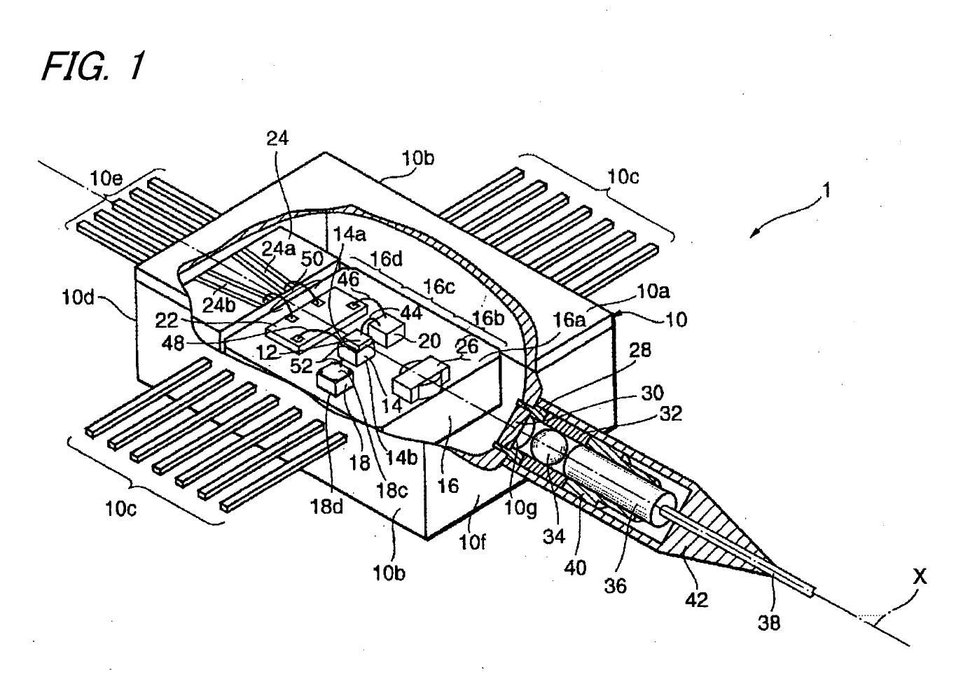

FIG. 1 is a partially broken perspective view of the light-transmitting module 1. The module 1 includes a housing 10, a light-transmitting device 12, a sub-mount 14, a carrier 16, a first post 18, a second post 20, a driver 22, a substrate 24, a first lens 26, a cylindrical member 28, a hermetic glass 30, a lens holder 32, a second lens 34, a ferrule 36, an optical fiber 38, a ferrule holder 40, and a boots 42. The light-transmitting device 12 may be a semiconductor laser diode (LD) or a semiconductor light-emitting diode (LED).

The housing 10 has a space, in which the various optical parts described above are installed. The space is formed by an upper wall 10a, a pair of side walls 10b, a rear wall 10d, a front wall 10f, and a bottom wall. On the side walls 10b and the rear wall 10d are provided a plurality of lead terminals 10c. An aperture 10g is formed in the front wall 10f.

The space installs the light-transmitting device 12 mounted on the sub-mount 14 made of insulating material such as aluminum nitride (AlN) having a good thermal conductivity. The sub-mount 14 has a first surface 14a and a second surface 14b opposite to the first surface 14a. Both surfaces 14a and 14b of the sub-mount are covered by metal films such as gold (Au) film formed by the evaporation. The light-transmitting device 12 is mounted on the first surface 14a with a eutectic metal such as gold-tin (AuSn) alloy. The sub-mount 14 is mounted on a surface 16a of the carrier 16.

The carrier 16 is made of electrical conductive material with a good thermal conductivity, such as copper tungsten (CuW). The surface 16a of the carrier 16 is divided into three regions from 16b to 16d arranged along a reference axis X in this order. The sub-mount 14, on which the light-transmitting device is mounted, is installed in the second region 16c such that the second surface 14b faces and in contact with the carrier 16 with gold-tin eutectic alloy. The light-transmitting device 12 has a light-emitting facet and a light-reflecting facet opposite to the light-emitting facet, and is mounted on the carrier 16 such that the both facets are arranged along the reference axis X. Also, the light-transmitting device 12 has first and second electrodes, and emits light by supplying a current between the first and second electrodes thereof. The light-transmitting device 12 is mounted on the sub-mount 14 such that the first electrode thereof faces and is in contact with the metal film 14a provided on the sub-mount 14. When the light-transmitting device is driven by cathode electrode thereof, then the first electrode above mentioned is the cathode electrode, while the second electrode corresponds to the anode electrode. On the other hand, the light-transmitting device is driven by the anode electrode thereof, then the first electrode is the anode and the second electrode corresponds to the cathode thereof.

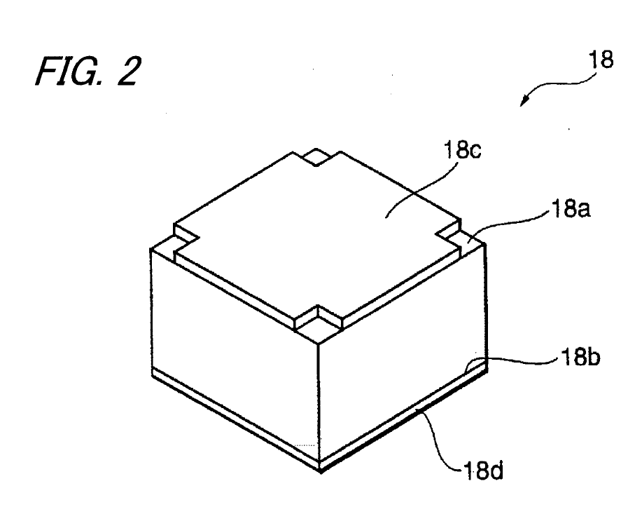

The first and second posts 18 and 20 are arranged both sides of the sub-mount 14 on the carrier 16. The first post 18 is made of insulating material such as aluminum nitride (AlN) and aluminum oxide (Al₂O₃). FIG. 2 is a perspective view showing the first post 18. The first post 18 includes a first surface 18a and a second surface 18b opposite to the first surface 18a. On the first surface 18a is provided a metal film 18c, while another metal film 18d is formed on the second surface 18b. The metal film 18c on the first surface 18a is formed into a designated pattern such as a cross. These metal films 18c and 18d may be formed by the evaporation of gold (Au). The first post 18 is mounted on the carrier 16 such that the second surface 18b thereof faces and in contact with the carrier 16 with a eutectic gold-tin alloy.

The second post is made of electrically conductive material such as copper tungsten (CuW). The second post is connected to the second electrode of the light-transmitting device 12 via a bonding-wire 44. By placing the second post 20 immediately side of the light-transmitting device 12, a length of the bonding-wire 44 may be shortened, thereby reducing the influence of the parasitic inductance of the bonding-wire, and accordingly enhancing the high frequency performance of the light-transmitting module 1.

On the third region 16d of the carrier 16 is mounted the driver 22 that provides the driving signal to the light-transmitting device 12. The bonding-wire 46 connects the driver 22 and the second post 20, whereby the second electrode of the light-transmitting device 12 is connected to the driver 22. While, the bonding-wire 48 connects the driver 22 to the metal film on the first surface 14a of the sub-mount 14, whereby the first electrode of the light-transmitting device is electrically connected to the driver.

The driver 22 is electrically connected to the substrate 24, which is also installed in the housing 10. The substrate 24 has transmission lines 24a and 24b thereon, and these lines 24a and 24b are connected to the driver 22 via bonding-wires 50.

On the first region 16b of the carrier 16 is mounted the first lens 26 that is optically coupled to the light-emitting facet of the light-transmitting device 12.

The cylindrical member 28, which secures the hermetic glass 30, is attached in the front wall 10f of the package 10 such that the member 28 surrounds the aperture 10g. The cylindrical member 28 also secures the lens holder 32 on one end thereof. The lens holder 32 holds the second lens 34, which is optically coupled to the first lens 26, whereby light emitted from the light-emitting facet of the light-transmitting device 12 is concentrated on the optical fiber via the first and second lens 26 and 34.

The ferrule 36 covers a tip portion of the optical fiber 38, and the ferrule holder 40 secures the ferrule 36. One end of the ferrule holder 40 is fixed to one end of the lens holder 32. Further, the cylindrical member 28, the lens holder 32 and the ferrule holder are covered by the boot 42.

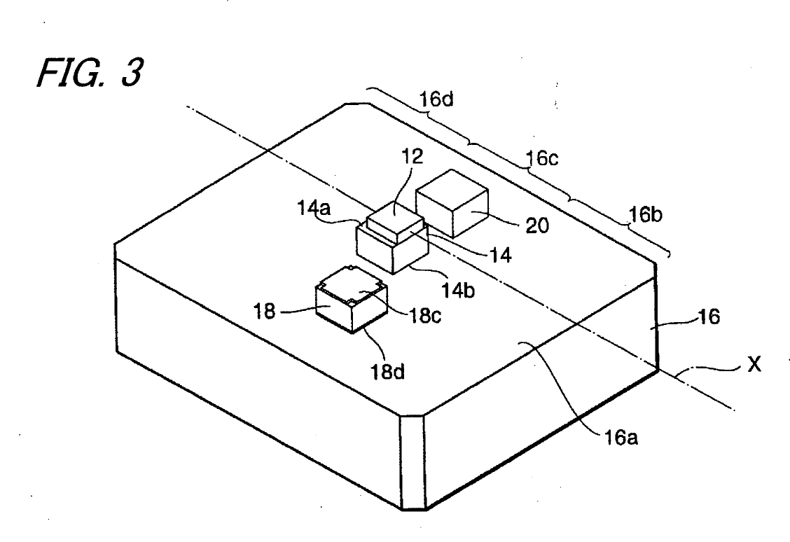

Next, a method for manufacturing the light-transmitting module 1 will be described. First, as shown in FIG. 3, which is a perspective view of the carrier 16 and components mounted thereon, the sub-mount 14 with the light-transmitting device 12 thereon is installed on the second region 16c of the carrier 16. The first post 18 and the second post 20 are also installed both sides of the sub-mount 14 on the carrier 16. These components of the sub-mount 14, the first 18 and the second 20 posts may be installed on the carrier 16 with accuracy by the pattern recognition technique with the periphery shape of the carrier 16 as a reference.

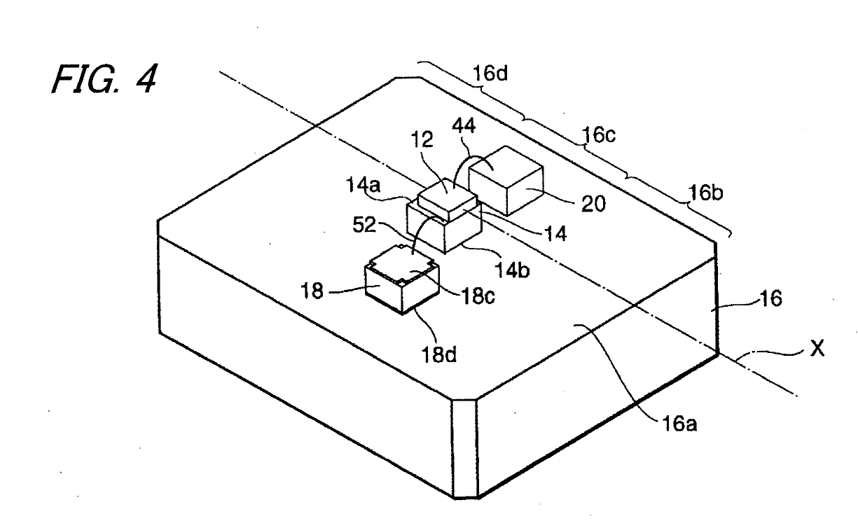

FIG. 4 is a perspective view of the carrier 16 with the light-transmitting device 12, the first 18 and the second 20 posts installed thereon. Subsequently to the first step described before, the second electrode of the light-transmitting device 12 is wire-bonded to the second post 20 with the bonding-wire 44, and the metal film of the first surface 14a of the sub-mount 14 is wire-bonded with the bonding-wire 52 to the metal film 18c of the first post 18.

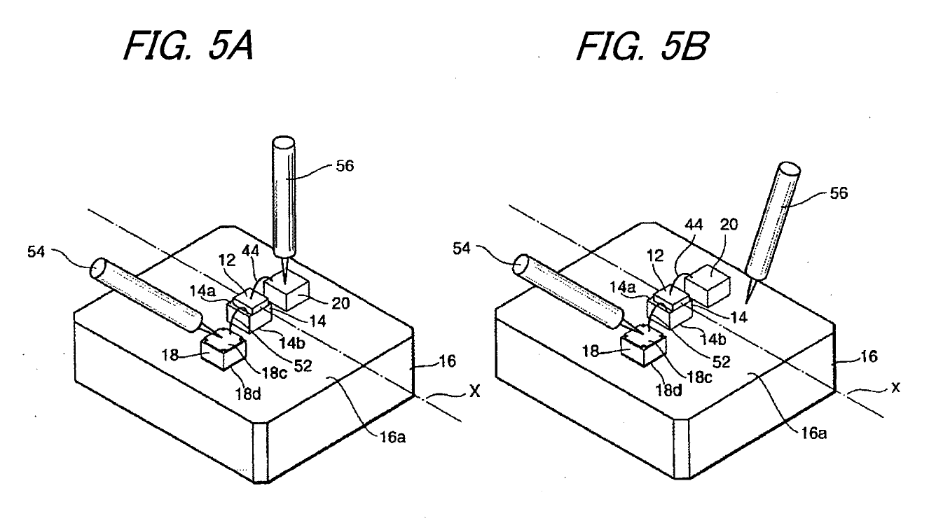

FIG. 5A shows an appearance when the light-transmitting device 12 is electrically turned on. In the next step, as shown in FIG. 5A, a screening test is performed by supplying the current to the light-transmitting device 12 via the first 54 and the second 56 probes. The first probe 54 is in contact with the metal film 18c on the first post 18, while the second probe 56 is in contact with the second post 20. The second probe 56 may be in contact with the surface of the carrier 16 as shown in FIG. 5B.

The position of the first 18 and the second post 20 are accurately recognized by the pattern recognition with the shape of the metal film 18c provided on the first post 18 as a reference. By supplying the current to the light-transmitting device 12 via the first 56 and the second 58 probes and checking whether the electrical to optical performance of the light-transmitting device 12 satisfies a predetermined condition or not. Thus, the screening test may be performed. In this test, since the current can be provided through two probes 54 and 56, the light-transmitting device 12 can be checked in advance to install the device into the package.

Occasionally, the screening test is done under biased condition such as a high temperature of 85° C. and a large current over 120 mA. However, assembled module shown in FIG. 1, especially the driver 22, may not withstand such hard condition. According to the preset method, as shown in FIG. 5, the light-transmitting device 12 is checked in advance to be installed within the housing 10, thereby enabling the biased screening test.

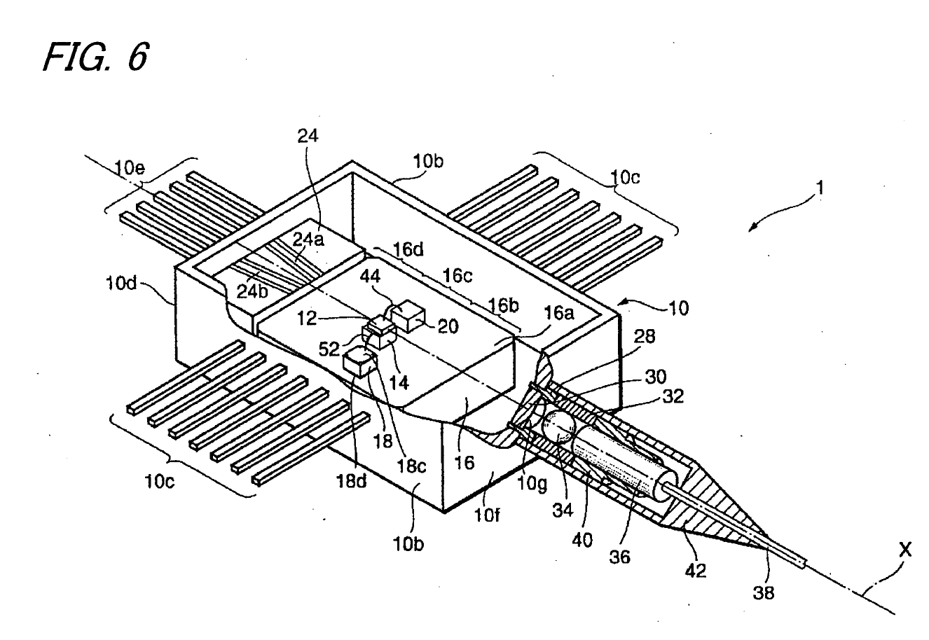

FIG. 6 is a perspective view in which the carrier 16 is installed into the housing 10.

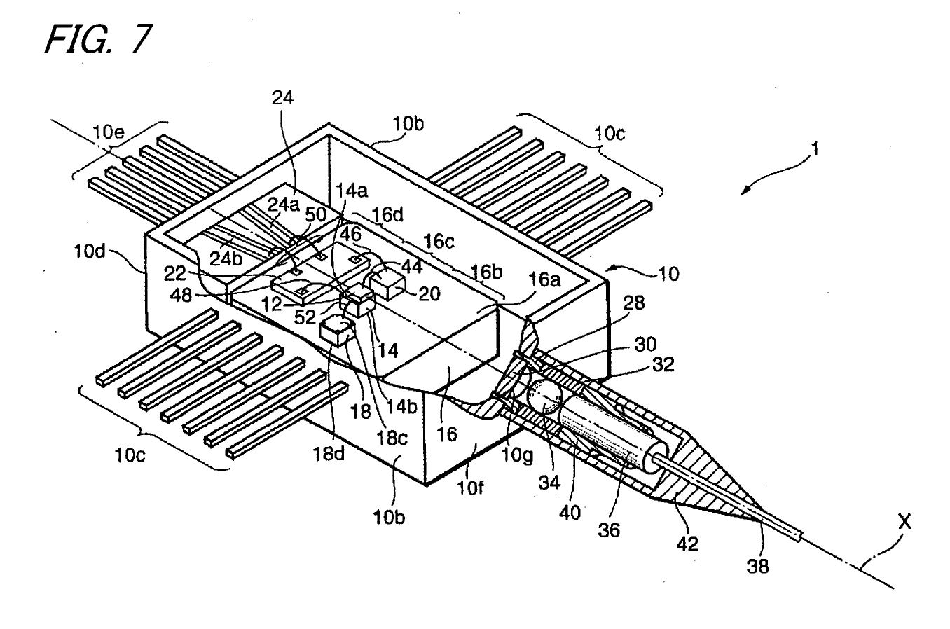

FIG. 7 shows an appearance in which the driver 22 is mounted on the third region 16d of the carrier 16. The third region 16d is recognized by the pattern recognition with the metal film 18c provided on the fist post 18 as a reference, whereby the driver 22 may be accurately installed just beside the light-transmitting device 12. To operate the light-transmitting device 12 in high frequency, it is necessary to place the driver 22 as close as the light-transmitting device 12 to reduce the parasitic inductance of the bonding-wire connecting each other. According to the present method, since the pattern recognition technique can be used with the metal film 18c of the first post 18 as the reference, the driver 22 can be disposed close to the light-transmitting device 12.

In this manufacturing step, the bonding-wire 46 connects the driver 22 to the second post 20, and another bonding-wire 48 connects the metal film on the first surface 14a of the sub-mount 14 to the driver 22. Further, the transmission lines 24a and 24b on the substrate 24 are connected to the driver 22 with bonding-wires 50.

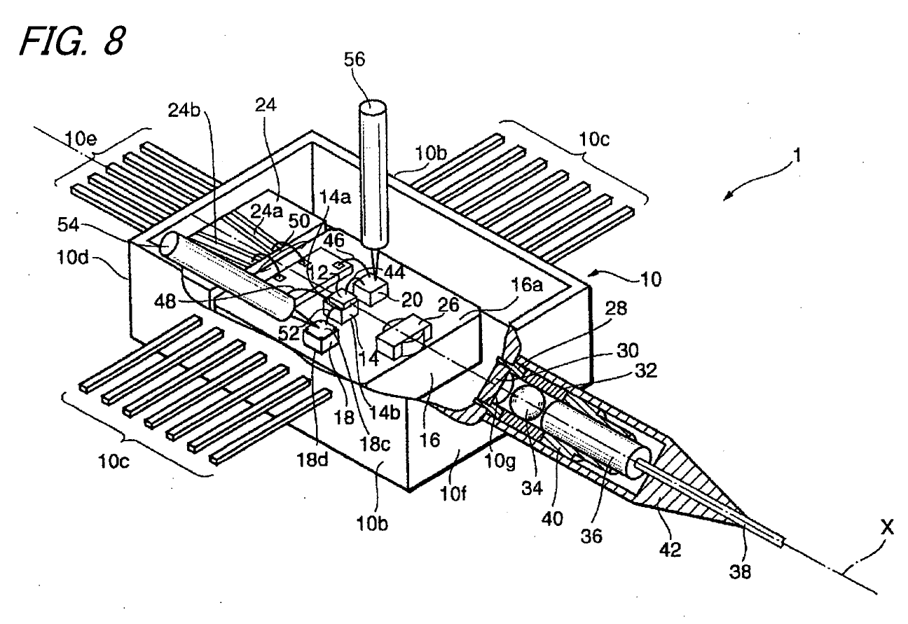

FIG. 8 shows an appearance in which the first lens is optically aligned. In this step, the first lens is installed in the first region 16b of the carrier and optically coupled with the light-emitting facet of the light-transmitting device 12. The first probe 54 touches to the metal film 18c provided on the fist post 18, while the second probe 56 touches to the second post, thereby supplying the current to the light-transmitting device 12. Similar to the screening test previously described, the first 18 and the second posts 20 can be recognized by the pattern recognition technique with the metal film 18c on the fist post 18 as the reference, thus the first 54 and the second probes 56 can be positioned.

The optical alignment of the first lens 26 can be done while the light emits from the light-emitting facet of the light-transmitting device 12 by supplying the current via the first 54 and the second probes 56.

To provide the current to the light-transmitting device 12 through the driver 22 results on the change of the far-field pattern of the light-transmitting device due to the Joule heating of the driver 22, which influences the optical alignment of the first lens 26. According to the present method, since the current is supplied from the first 54 and the second probes 56 without relaying the driver 22, the light-transmitting device can avoid the Joule heating, whereby the alignment of the first lens 26 can be performed with accuracy.

Subsequent to the optical alignment of the first lens 26, the bonding-wire 52 connecting the first post to the upper surface of the sub-mount 14 is removed. To remove the bonding-wire 52 eliminates the parasitic capacitance due to the first post 18. Sealing the housing 10 by the upper wall 10a completes the light-transmitting module 1 shown in FIG. 1.

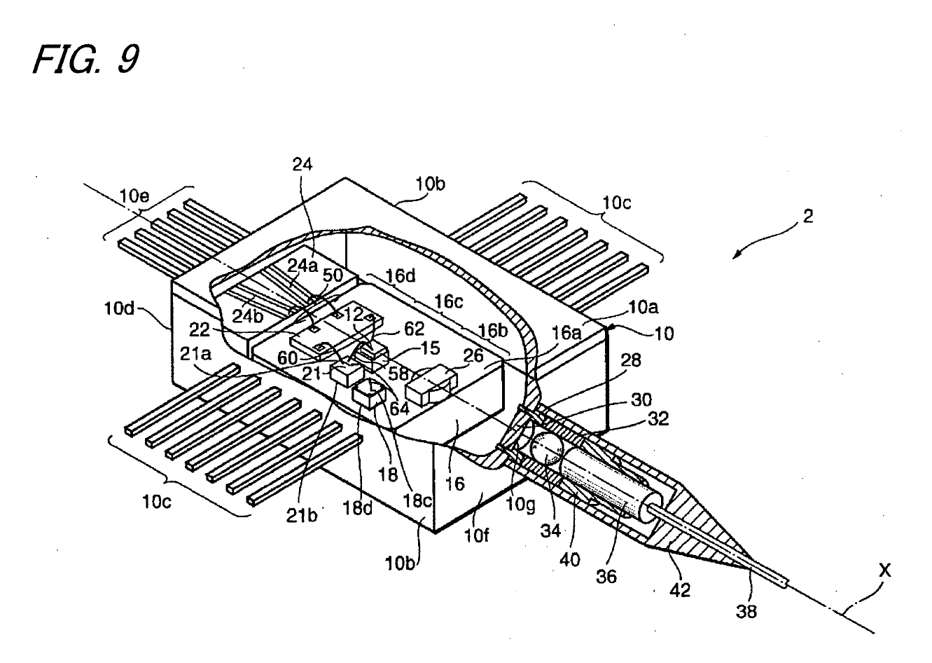

Next, the second embodiment according to the present invention will be described. FIG. 9 is a partially broken perspective view of a light-transmitting module 2 of the second embodiment. In the description below, elements different to those of the light-transmitting module 1 of the first embodiment will be described. The light-transmitting module 2 of the second embodiment includes a third post 21 instead of the second post 20 of the first embodiment.

Moreover in the second embodiment, the sub-mount 15 mounting the light-transmitting device thereon is made of electrically conductive material such as copper tungsten (CuW). The sub-mount 15 is mounted on the carrier with gold-tin eutectic (AuSn) alloy. The bonding-wire 62 connects the sub-mount 15 to the driver 22, thus the second electrode of the light-transmitting device 12 is connected to the driver 22 via the sub-mount 15 and the bonding-wire 62.

The third post 21 is made of insulating material such as aluminum nitride (AlN) and aluminum oxide (AlN₂O₂). The third post 21 has a first surface 21a and a second surface 21b opposite to the first surface 21a. Both surfaces 21a and 21b provide metal films thereon, such as gold formed by the evaporation.

The another electrode of the light-transmitting device 12, the first electrode, is connected to the first surface 21a of the third post 21 via the bonding-wire 58, while the fist surface 21a of the third post is connected to the driver 22 via the bonding wire 60 and the metal film 18a provided on the first post 18 via the bonding-wire 64. Accordingly, the first electrode of the light-transmitting device 12 is connected to the driver 22 via the bonding-wire 58, the third post and the bonding-wire 60, and also connected to the metal film 18a on the first post 18 via the bonding-wire 58, the third post and the bonding-wire 64.

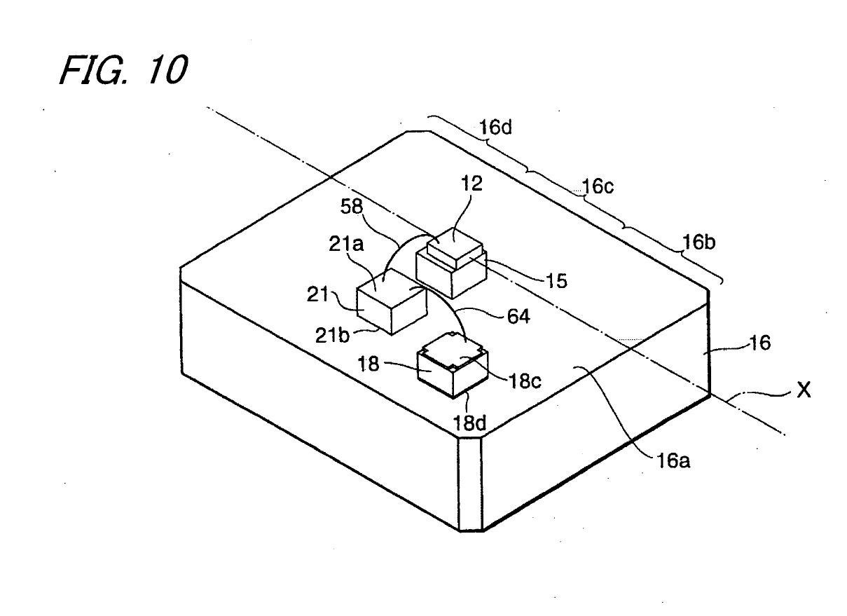

Next, the method of manufacturing the light-transmitting module 2 will be described hereinbelow. In the description, features different to the method for the first embodiment will be explained. As shown in FIG. 10, the wire-bonding between the light-transmitting device 12, the first post and the third post is different to those of the first embodiment. The carrier 16 mounts the sub-mount 15, on which the light-transmitting device is mounted, the first post 18 and the third post 21. The first electrode that is electrically isolated from the sub-mount 15 and the first surface 21a of the third post 21 is connected with the bonding-wire 58. The first surface 21a is also connected to the metal film 18c on the first post 18, thus the first electrode of the light-transmitting device 12 is connected to the first post via the bonding-wire 58, the third post 21 and the bonding wire 64. On the other hand, the second electrode of the light-transmitting device 12 is connected to the carrier via the conductive sub-mount 15.

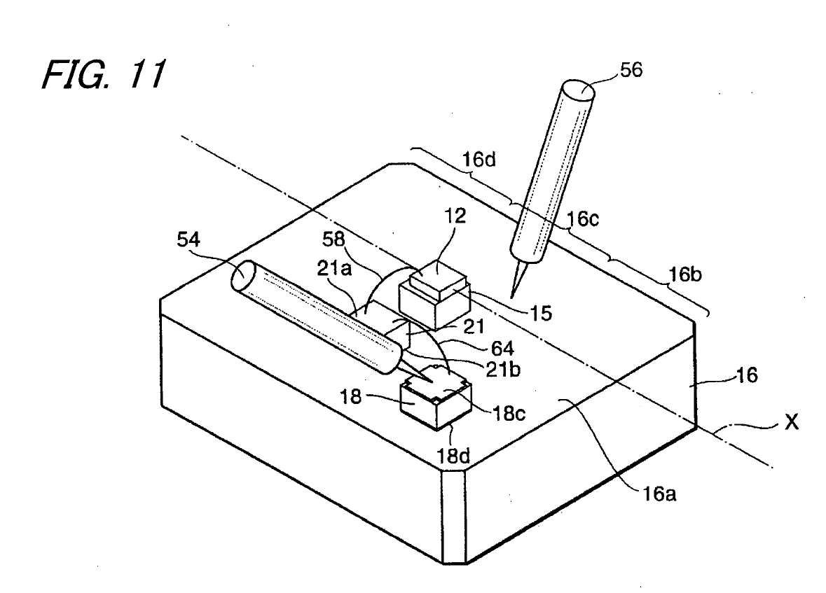

In the screening test, as shown in FIG. 11, the first probe 54 touches to the metal film 18c on the first post 18, while the second probe 56 directly touches to the carrier 16, thereby supplying the current to the light-transmitting device 12.

Also, in the alignment process of the first lens 26, the first probe 54 and the second probe 56 touch to the metal film 18c and the carrier 16, respectively.

After alignment of the first lens 26, the bonding-wire 64 connecting the first 18 and the third posts 21 is cut, and setting the upper wall 10a on the side walls from 10b, 10d and 10f, the light-transmitting module 2 is completed.

According to the present invention thus described, the screening test can be done before the light-transmitting device is set within in the package. Therefore, defective device can be removed without dropping other components such as the driver and the housing, which reduces the total cost of the module.

1. A method for manufacturing a light-transmitting module having a light-transmitting device, an electrically conductive carrier, a lens and a housing, said housing enclosing said light-transmitting device, said carrier and said lens, said light-transmitting device having a first electrode and a second electrode and transmitting light by supplying a current between said first and second electrodes, said method comprising the steps of:
mounting a sub-mount and a first post on said conductive carrier, said sub-mount mounting said light-transmitting device thereon, said first post being made of insulating material with a metal film thereon;
electrically connecting said first electrode of said light-transmitting device to said metal film on said first post; and
testing said light-transmitting device by supplying said current through a first probe touching said metal film on said first post.

2. The method according to claim 1, wherein said sub-mount is made of insulating material having a first surface with a metal film thereon, said light-transmitting device being mounted on said sub-mount such that said first electrode of said light-transmitting device faces and is in contact with said metal film on said first surface of said sub-mount.

3. The method according to claim 2, wherein said electrically connecting step further comprises a step of electrically connecting said second electrode of said light-transmitting device to said carrier.

4. The method according to claim 2, wherein said mounting step further comprises a step of mounting an electrically conductive second post on said carrier, and said electrically connecting step further comprises a step of electrically connecting said second electrode of said light-transmitting device to said second post.

5. The method according to claim 1, subsequently to said testing step, further comprises steps of
installing said carrier, on which said light-transmitting device and said first post are mounted, into said housing; and
mounting said lens on said carrier and aligning said lens with said light-transmitting device by supplying said current to said light-transmitting device through said first probe touching said metal film on said first post.

6. The method according to claim 5, subsequently to said alignment of said lens, further comprises steps of:
cutting said electrical connection between said first electrode of said light-transmitting device and said metal film on said first post;
mounting a driver for driving said light-transmitting device on said carrier; and
electrically connecting said driver to said first electrode and said second electrode of said light-transmitting device.

7. The method according to claim 1, wherein said sub-mount is made of electrically conductive material and said light-transmitting device is mounted on said sub-mount such that said second electrode of said light-transmitting device faces and is in contact with said sub-mount.

8. The method according to claim 7, wherein said mounting step further comprises a step of mounting a third post on said carrier, said third post being made of insulating material having another metal film thereon, and said electrically connecting step further comprises a step of electrically connecting said first electrode of said light-transmitting device to said metal film provided on said first post through said other metal film provided on said third post.

9. The method according to claim 8, after said electrically connecting step between said first electrode of said light-transmitting device and said metal film provided on said first post, further comprises steps of:
cutting said electrical connection between said metal film provided on said first post and said other metal film on said third post;
mounting a driver for driving said light-transmitting device on said carrier; and
electrically connecting said driver to said other metal film provided on said third post.

10. The method according to claim 1, wherein said first electrode is a cathode electrode of said light-transmitting device and said second electrode corresponds to an anode electrode of said light-transmitting device.
